(19) United States
(12) Patent Application Publication
(10) Pub. No.: US 2026/0186872 A1
(43) Pub. Date: Jul. 2, 2026

(54) SYSTEM AND METHOD FOR OPTIMIZING MESSAGING WITH AN ECOSYSTEM

(71) Applicant: Universal Electronics Inc., Scottsdale, AZ (US)

(72) Inventor: Arsham Hatambeiki, San Diego, CA (US)

(21) Appl. No.: 19/057,689

(22) Filed: Feb. 19, 2025

Related U.S. Application Data
(63) Continuation-in-part of application No. 19/006,976, filed on Dec. 31, 2024.

(51) Int. Cl. G06F 9/54

(52) U.S. Cl. CPC G06F 9/542

(57) ABSTRACT

Stored in memory is a plurality of first data each of which is indicative of a priority that is assigned to each one of a plurality of notification sink devices determined to be within a home environment. In response to a notification message being generated by a notification source device, an operating state of each of the plurality of notification sink devices is determined, the determined operating state of each of the plurality of notification sink devices and the first data is used to identify a one of the plurality of notification sink devices, and the notification message is caused to be routed to the identified one of the plurality of notification sink devices.

### RELATED APPLICATION INFORMATION

This application claims the benefit of and is a continuation-in-part of U.S. application Ser. No. 19/006,976, filed on Dec. 31, 2024, which application is incorporated herein by reference in its entirety.

### BACKGROUND

Systems and methods that generally function to automatically identify an electronic device are known in the art. For example, U.S. Pat. No. 12,073,711 describes a method for configuring a controlling device that relies upon information obtained during device discovery processes. While the methods described in U.S. Pat. No. 12,073,711 work for their intended purpose, what is needed in the art is a system and method for optimizing messages intended for a home or user, particularly a system and method that ensures messages are routed consider a level of (1) privacy, (2) importance, (3) target (e.g., household vs user), and/or (4) timeliness while reducing the delivery of redundant/spammy messages (e.g., the sending of multiple message to a user across different places/platforms they can be reached).

### SUMMARY

To address this need, the following describes example systems and methods that function to detect, register, and track connected appliances and users within an ecosystem and to use obtained information to, among other things, optimize messaging within the system.

More particularly, stored in memory is a plurality of first data each of which is indicative of a priority that is assigned to each one of a plurality of notification sink devices determined to be within a home environment. In response to a notification message being generated by a notification source device, an operating state of each of the plurality of notification sink devices is determined, the determined operating state of each of the plurality of notification sink devices and the first data is used to identify a one of the plurality of notification sink devices, and the notification message is caused to be routed to the identified one of the plurality of notification sink devices. The operating state of each of the plurality of notification sink devices comprises one or more of a location state of at least one user relative to each of the plurality of notification sink devices. a power state of each of the plurality of notification sink devices, and a location state of each of the plurality of notification sink devices.

A better understanding of the objects, advantages, features, properties and relationships of the invention will be obtained from the following detailed description and accompanying drawings which set forth illustrative embodiments and which are indicative of the various ways in which the principles of the invention may be employed.

### BRIEF DESCRIPTION OF THE DRAWINGS

For a better understanding of the various aspects of the described examples, reference may be had to preferred embodiments shown in the attached drawings in which:

FIGS. 1 and 2 illustrate example systems in which a standalone device may be utilized to command operation of several controllable devices;

FIGS. 3 and 4 illustrate example systems in which configuration related functionality may be incorporated into a device which is part of a home entertainment system;

FIG. 5 illustrates a block diagram of an example configurable device;

FIG. 6 illustrates a graphical representation of an example control environment;

FIG. 7 illustrates an example preferred command matrix for use in a control environment, for example as illustrated in FIG. 6;

FIG. 8 illustrates a block diagram of an example smart device which may support a remote control app and a setup method for use in configuring a device;

FIG. 9 illustrates an example series of steps which may be performed in order to set up and configure an example device;

FIG. 10 illustrates an example series of steps which may be performed in order to define to a device a device configuration which corresponds to a user activity;

FIG. 11 illustrates example activity configuration matrices such as may be defined during the steps of FIG. 10;

FIG. 12 illustrates an example current device state matrix which may be maintained by a device for use in determining the commands necessary to invoke one of the states defined by the matrix of FIG. 11;

FIG. 13 illustrates an example series of steps which may be performed by a device in issuing a function command to another device;

FIG. 14 illustrates an example series of steps which may be performed by a device in establishing device states matching a desired activity defined in one of the matrices of FIG. 11;

FIG. 15 illustrates an example series of steps which may be performed by a smart device to setup command control macros;

FIG. 16 illustrates an example series of steps which may be performed to use a tracked condition of a first device to enhance services provided by one or more apps installed on the first device and/or other devices;

FIG. 17 illustrates an example of device and/or user tracking within a home environment;

FIG. 18 illustrates an example of audio control within a home environment; and

FIG. 19 illustrates an example method for routing a notification within the home environment.

### DETAILED DESCRIPTION

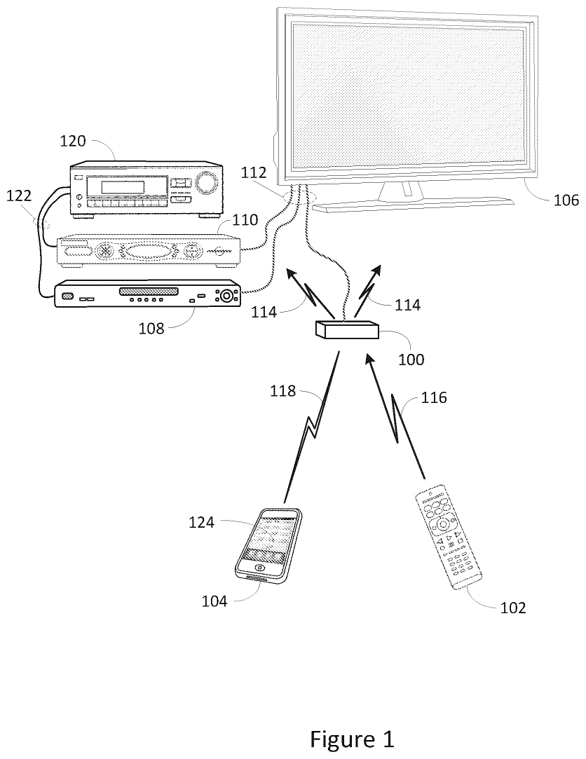

With reference to FIG. 1, there is illustrated an example system in which a device 100 may be used to issue commands to control various controllable devices, such as a television 106, a cable set top box combined with a digital video recorder (“STB/DVR”) 110, a DVD player 108, and an AV receiver 120. While illustrated in the context of a television 106, STB/DVR 110, a DVD player 108, and an AV receiver 120, it is to be understood that controllable devices may include, but need not be limited to, televisions, VCRs, DVRs, DVD players, cable or satellite converter set-top boxes (“STBs”), amplifiers, CD players, game consoles, home lighting, drapery, fans, HVAC systems, thermostats, personal computers, smart phones, smart watches, and the like that are adapted to receive and/or transmit communications via a wired and/or wireless network which may be a local area network and/or a wide-area network. In the illustrative example of FIG. 1, device commands may be issued by device 100 in response to infrared (“IR”) request signals 116 received from a remote control device 102, radio frequency (“RF”) request signals 118 received from an app 124 resident on a smart device 104, or any other device from which device 100 may be adapted to receive requests, using any appropriate communication method. As illustrated, transmission of the requested device commands from the device 100 to other devices 106,108,112,120 may take the form of wireless IR signals 114 or CEC commands issued over a wired HDMI interface 112, as appropriate to the capabilities of the particular device to which each command may be directed. In particular, in the example system illustrated, AV receiver 120 may not support HDMI inputs, being connected to audio source devices 108,110 via, for example S/PDIF interfaces 122. Accordingly, device 100 may be constrained to transmit all commands destined for AV receiver 120 exclusively as IR signals, while commands destined for the other devices 106 through 110 may take the form of either CEC or IR signals as appropriate for each command. By way of example without limitation, certain TV manufacturers may elect not to support volume adjustment via CEC. If the illustrative TV 106 is of such manufacture, device 100 may relay volume adjustment requests to TV 106 as IR signals 114, while other requests such as power on/off or input selections may be relayed in the form of CEC commands over HDMI connection 112.

It will be appreciated that, while illustrated in the context of IR, RF, and wired CEC signal transmissions, in general, transmissions to and from device 100 may take the form of any convenient IR, RF, hardwired, point-to-point, or networked protocol, as necessary for a particular embodiment. Accordingly, devices may communicate using other known communication technologies such as IP commands sent through a WiFi network, or a Thread network, or Zigbee commands, or Bluetooth LE commands, etc. Further, while wireless communications 116, 118, etc., between example devices are illustrated herein as direct links, it should be appreciated that in some instances such communication may take place via a local area network or personal area network, and as such may involve various intermediary devices such as routers, bridges, access points, etc. Since these items are not necessary for an understanding of the instant invention, they are omitted from this and subsequent Figures for the sake of clarity.

Since smart device remote control apps such as that contemplated in the illustrative device 104 are well known, for the sake of brevity the operation, features, and functions thereof will not be described in detail herein. Nevertheless, if a more complete understanding of the nature of such apps is desired, the interested reader may turn to, for example, the before mentioned U.S. patent application Ser. No. 12/406,601 or U.S. patent application Ser. No. 13/329,940, (now U.S. Pat. No. 8,243,207).

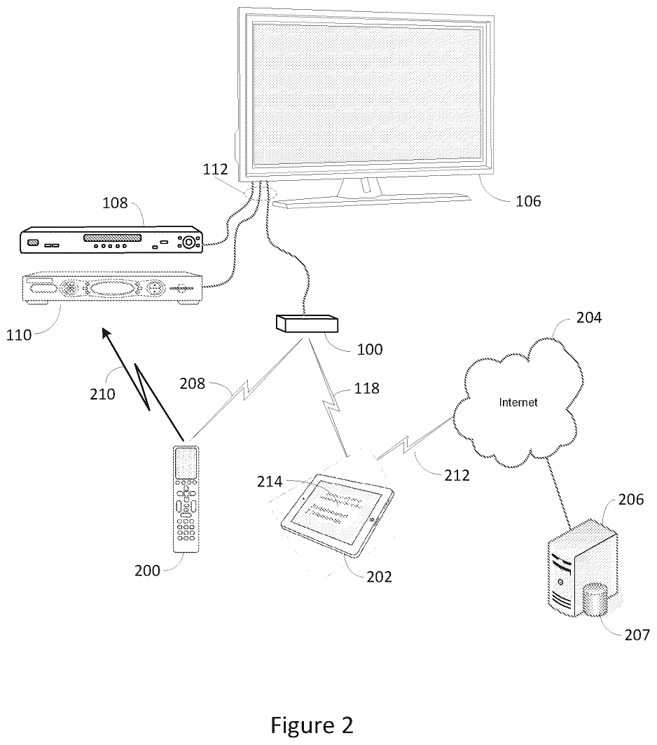

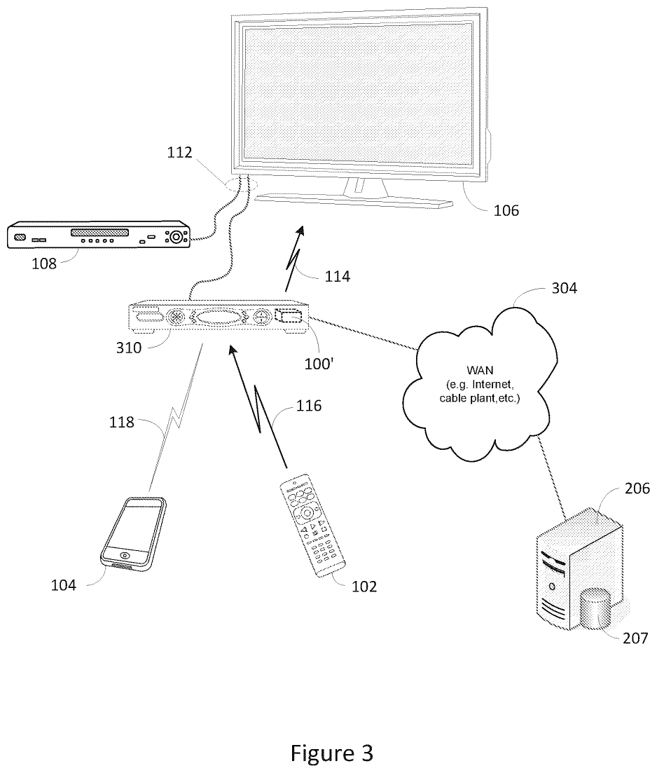

Turning now to FIG. 2, in a further illustrative embodiment, device 100 may receive wireless request signals from a remote control 200 and/or an app resident on a tablet computer 202. As before, command transmissions to devices 106,108,110 may take the form of wired CEC commands or wireless IR commands. However, in this example remote control 200 may be in bi-directional communication 208 with device 100 and accordingly the device 100 may delegate the transmission of IR commands 210 to the remote control device 200, i.e., use remote control 200 as a relay device for those commands determined to be best executed via IR transmissions. As also generally illustrated in FIG. 2, a setup app 214 executing on a smart device such as tablet computer 202 may be utilized in conjunction with an Internet (212,204) accessible or cloud based server 206 and associated database 207 to initially configure device 100 for operation with the specific group of devices to be controlled, i.e., to communicate to device 100 a matching command code set and capability profile for each particular device to be controlled, for example based on type, manufacture, model number, etc., as will be described in greater detail hereafter. With reference to FIG. 3, in a further illustrative embodiment the configuration functionality that is provided to the dedicated controlling device 100 may be embedded in a device, for example STB/DVR 310, having additional functionality. In this example, remote control 102 and/or smart device 104 may transmit wireless request signals directly to STB/DVR 310 for action by functionality 100′, which actions may, as before, comprise CEC command transmissions via HDMI connection 112 or IR command transmissions 114, originating in this instance from an IR blaster provisioned to the STB/DVR device 310. In this configuration, a set up application resident in STB/DVR 310 may be utilized to configure functionality 100′, using for example an Internet connection 304 accessible through a cable modem and/or cable distribution system headend.

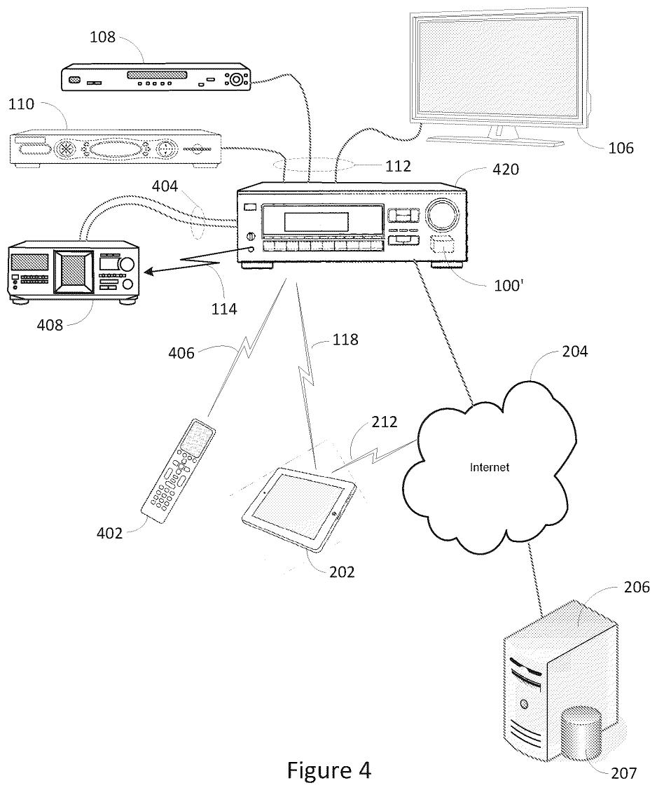

In the further illustrative embodiment of FIG. 4, the functionality 100′ may be embedded in an AV receiver 420 which may serve as an HDMI switch between various content sources such as a STB/DVR 110 or a DVD player 108 and a rendering device such as TV 106. In addition to HDMI inputs, AV receiver 420 may also support various other input formats, for example analog inputs such as the illustrative 404 from CD player 408; composite or component video; S/PDIF coaxial or fiberoptic; etc. In this embodiment, request signals 406 may be directed to AV receiver 420, for example from remote control 402, for action by the functionality 100′. As before, resulting device commands may be transmitted using CEC signals transmitted over HDMI connections 112, or via IR signals 114 transmitted from an associated IR blaster. As appropriate for a particular embodiment, initial configuration of the functionality 100′ to match the equipment to be controlled may be performed by an Internet-connected app resident in AV receiver 420, or by an app resident in tablet computer 202 or other smart device, as mentioned previously in conjunction with FIG. 2.

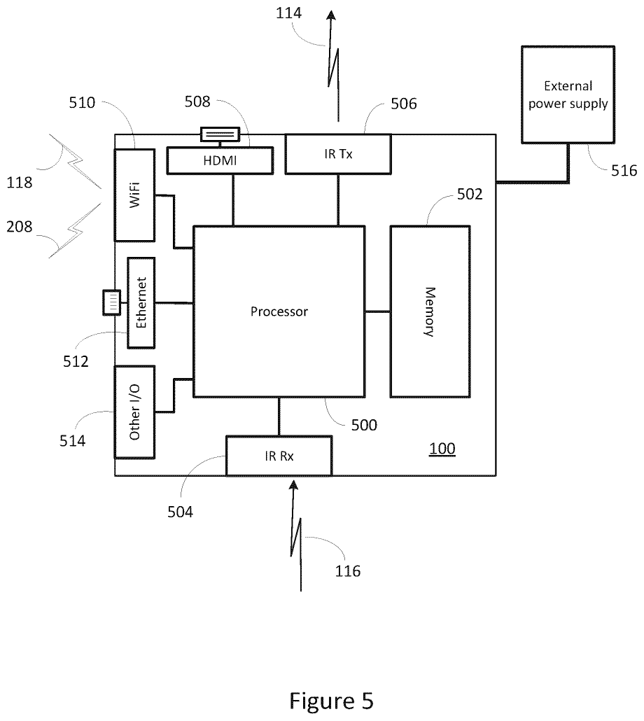

As will be appreciated, various other configurations are also possible without departing from the underlying configurable device concept, for example functionality 100′ may be incorporated into an Internet-capable TV, an HDMI switch, a game console, etc.; device command set and capability database 207 may be located at an internet cloud or a cable system headend, may be stored locally (in all or in part), which local storage may take the form of internal memory within the device having functionality 100′ itself or in an device such as a TV, STB or AV receiver, or may take the form of a memory stick or the like attachable to a smart device or device; etc. With reference to FIG. 5, an example device 100 (whether stand alone or in an a device supporting functionality 100′) may include, as needed for a particular application, a processor 500 coupled to a memory 502 which memory may comprise a combination of ROM memory, RAM memory, and/or non-volatile read/write memory and may take the form of a chip, a hard disk, a magnetic disk, an optical disk, a memory stick, etc., or any combination thereof. It will also be appreciated that some or all of the illustrated memory may be physically incorporated within the same IC chip as the processor 500 (a so called “microcontroller”) and, as such, it is shown separately in FIG. 5 only for the sake of clarity. Interface hardware provisioned as part of the example platform supporting the configuration functionality may include IR receiver circuitry 504 and IR transmitter circuitry 506; an HDMI interface 508; a WiFi transceiver and interface 510; an Ethernet interface 512; and any other wired or wireless I/O interface(s) 514 as appropriate for a particular embodiment, by way of example without limitation Bluetooth, RF4CE, USB, Zigbee, Zensys, X10/Insteon, HomePlug, HomePNA, etc. The electronic components comprising the example device 100 may be powered by an external power source 516. In the case of a standalone device 100, such as illustrated in FIGS. 1 or 2, this may comprise for example a compact AC adapter “wall wart,” while a device having the functionality 100′ and additional functionality, such as illustrated in FIGS. 3 or 4, may draw operating power from the device into which they are integrated. It will also be appreciated that in the latter case, in certain embodiments processor 500 and/or memory 502 and/or certain portions of interface hardware items 504 through 514 may be shared with other functionalities of the host device.

As will be understood by those skilled in the art, some or all of the memory 502 may include executable instructions that are intended to be executed by the processor 500 to control the operation of the device 100 as well as data which serves to define the necessary control protocols and command values for use in transmitting command signals to controllable devices (the command data). In this manner, the processor 500 may be programmed to control the various electronic components within the example device 100, e.g., to monitor the communication means 504,510 for incoming request messages from control devices, to cause the transmission of device command signals, etc. To cause the device 100 to perform an action, the device 100 may be adapted to be responsive to events, such as a received request message from remote control 102 or smart device 104, changes in connected device status reported over HDMI interface 508, WiFi interface 510, or Ethernet interface 512, etc. In response to an event, appropriate instructions within the programming may be executed. For example, when a command request is received from a smart phone 104, the device 100 may retrieve from the command data stored in memory 502 a preferred command transmission medium (e.g., IR, CEC over HDMI, IP over WiFi, etc.) and a corresponding command value and control protocol to be used in transmitting that command to an intended target device, e.g., TV 106, in a format recognizable by that device to thereby control one or more functional operations of that device. By way of further example, the status of connected devices, e.g., powered or not powered, currently selected input, playing or paused, etc., as may be discerned from interfaces 508 through 514, may be monitored and/or tabulated by the programming in order to facilitate adjustment of device settings to match user-defined activity profiles, e.g. “Watch TV”, “View a movie”, etc.

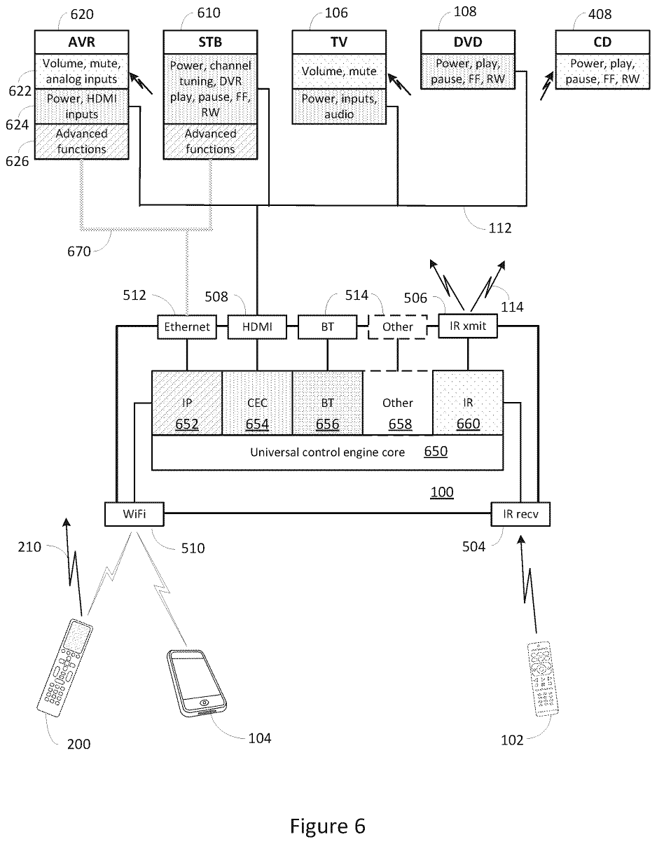

An overview of an example control environment is presented in FIG. 6. The programming of an example device 100 may comprise a universal control engine core 650 together with a series of scalable software modules 652 through 660, each module supporting a particular device command protocol or method and provisioned as appropriate for a particular embodiment. By way of example, the illustrative embodiment of FIG. 6 may include an internet protocol (IP) module 652, a CEC over HDMI module 654, a Bluetooth module 656, an IR module 660, a WiFi module, a Thread module, a Zigbee module, and/or other modules(s) 658, as appropriate for the particular application. The devices to be controlled may include an IP enabled AV receiver 620, an IP enabled STB/DVR 610, TV 106, DVD player 108, and CD player 408. As illustrated, certain of these devices may be interconnected via HDMI 112 and/or Ethernet 670 interfaces. In this regard, it should be appreciated that the illustrative interconnections 112 and 670 of FIG. 6 are intended to depict logical topography only and accordingly details of exact physical cabling structure and/or the presence of any necessary switches, routers, hubs, repeaters, interconnections, etc., are omitted for the sake of clarity.

The preferred method/protocol/medium for issuance of commands to the example devices of FIG. 6 may vary by both device and by the function to be performed. By way of example, volume control and analog input selection commands 622 targeted to AV receiver 620 may be required to be issued via IR transmissions, while power on/off and HDMI input selection functionality commands 624 may be better communicated via CEC commands and advanced functionality commands 626 such as sound field configuration may be best communicated via an Ethernet connection. In a similar manner, the various operational functions of the other devices may best commanded via a mixture of mediums, methods, and protocols, as illustrated. As will be appreciated, in some instances a particular device may support receipt of an operational command via more than one path, for example the power on/off function of AV receiver 620 may be available not only as a CEC command, but also via an IR command. In such instances, the preferred command format used by the device 100 may be that which has been determined to offer the greatest reliability, for example in the above instance the CEC command may be preferred since this form of command is not dependent on line-of-sight and also permits confirmation that the action has been performed by the target device.

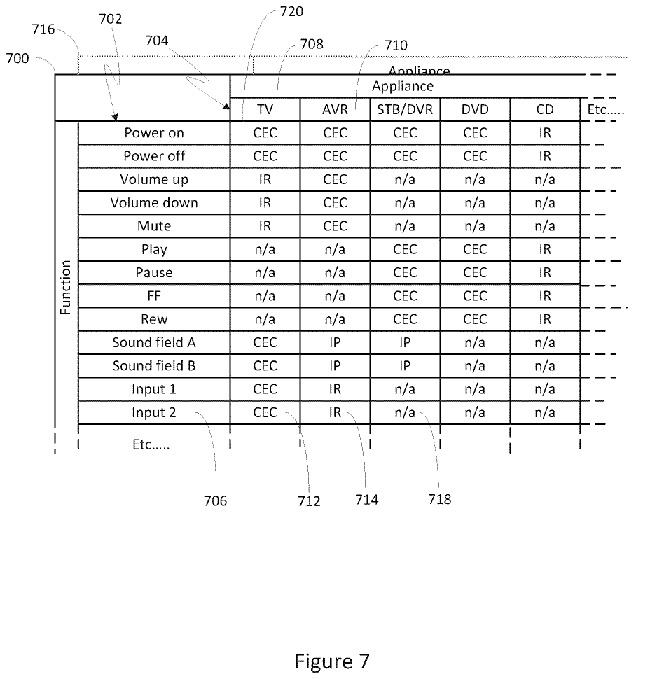

In order to determine the optimum method for each configured device type and command, the example core program 650 may be provisioned with a preferred command matrix 700, as illustrated in FIG. 7. Example preferred command matrix 700 may comprise a series of data cells or elements, e.g. cells 712, each corresponding to a specific command 702 and a specific one of the devices to be controlled 704. The data content of such a cell or element may comprise identification of a form of command/transmission to be used and a pointer to the required data value and formatting information for the specific command. By way of example, the data element 712 corresponding to the “Input 2” command 706 for the configured TV device 708, may comprise an indicator that a CEC command is to be used, i.e., an indicator of the transmission device that is to be used to communicate the command to the intended target device, together with a pointer to the appropriate command data value and HDMI-CEC bus address; while data element 714 corresponding to the same command function for the configured AV receiver 710 may comprise an indicator that an IR command is to be used, together with a pointer to appropriate command data and formatting information within an IR code library stored elsewhere in memory 502. In certain embodiments one or more secondary command matrices 716 may also be provisioned, allowing for the use of alternate command methods in the event it is determined by the programming that a preferred command was unsuccessful. Command matrix 700 may also contain null entries, for example 718, where a particular function is not available on or not supported by a specific device. In an example embodiment, command matrix 700 may be created and loaded into the memory 502 of device 100 during an initialization and set-up process, as will now be described in further detail.

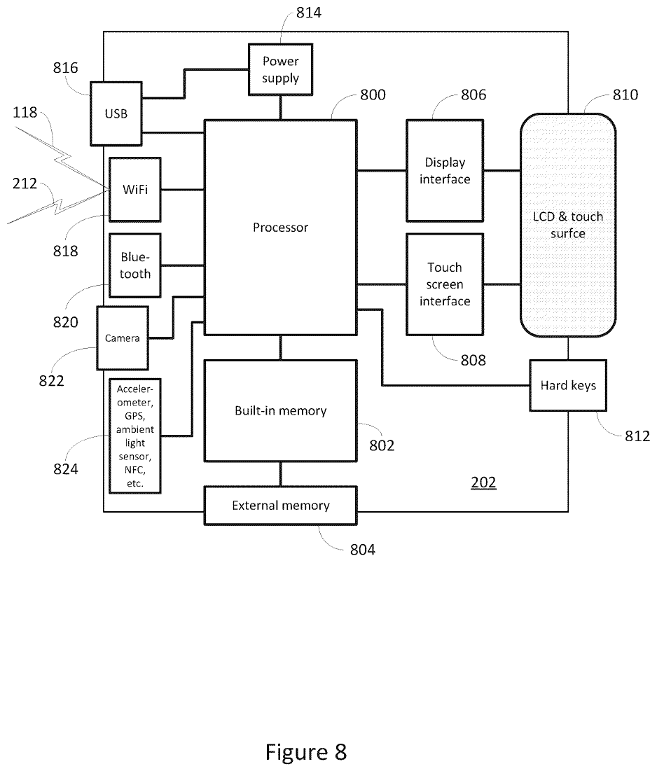

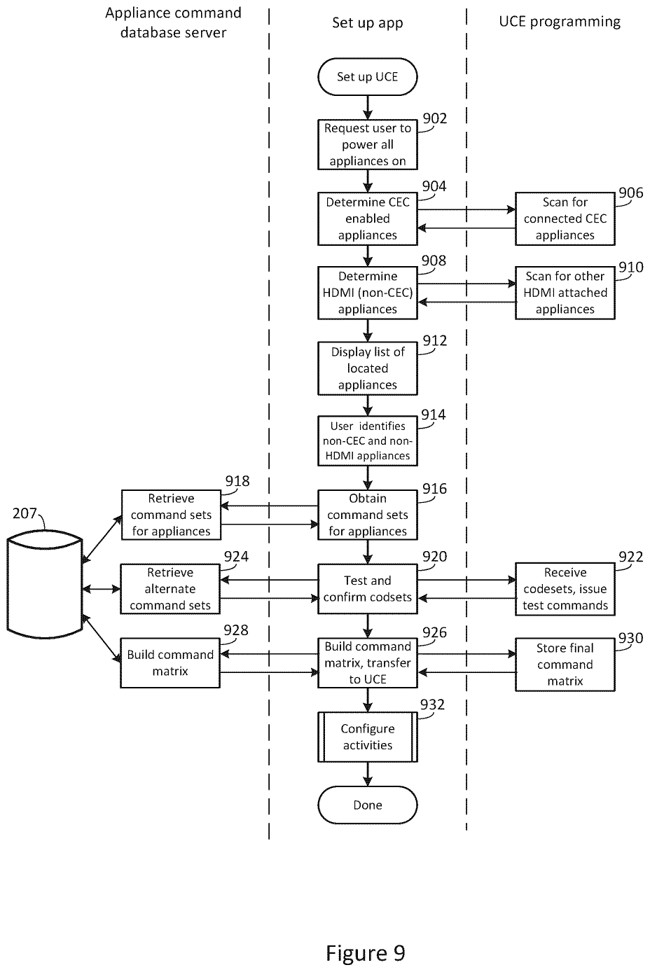

In order to perform initial configuration of a device 100, a setup application may be provided. In some embodiments, such a set up application may take the form of programming to be executed on any convenient device with a suitable user interface and capable of establishing communication with the device, such as without limitation a smart phone, tablet computer, personal computer, set top box, TV, etc., as appropriate for a particular embodiment. In other embodiments such a set up application may be incorporated into the programming itself, utilizing for example a connected TV screen and an associated control device as the user interface. Regardless of the exact form and location of the programming and user interface means, the series of steps which may be performed by a set up application when configuring a device for operation with a specific set of devices remains similar. Accordingly, it will be appreciated that the methods comprising the illustrative set up application presented below in conjunction with FIGS. 8 and 9 may be generally applied, mutatis mutandis, to various alternative set up application embodiments. With reference to FIG. 8, as known in the art a tablet computer such as the example device 202 of FIG. 2 may comprise, as needed for a particular application, a processor 800 memory 802 which memory may comprise a combination of ROM memory, RAM memory, and/or non-volatile read/write memory and may take the form of a chip, a hard disk, a magnetic disk, an optical disk, a memory stick, etc., or any combination thereof. In some embodiments, provision may also be made for attachment of external memory 804 which may take the form of an SD card, memory stick, or the like. Hardware provisioned as part of an example tablet computer platform may include an LCD touchscreen 810 with associated display driver 806 and touch interface 808; hard keys 812 such as for example a power on/off key; a USB port 816; WiFi transceiver and interface 818; a Bluetooth transceiver and interface 820; additional protocol transceivers and interfaces as needed, a camera 822; and various other features 824 as appropriate for a particular embodiment, for example an accelerometer, GPS, ambient light sensor, near field communicator; etc. The electronic components comprising the example tablet computer device 202 may be powered by a battery-based internal power source 814, rechargeable for example via USB interface 816.

Memory 802 may include executable instructions that are intended to be executed by the processor 800 to control the operation of the tablet computer device 202 and to implement various functionalities such as Web browsing, game playing, video streaming, etc. As is known in the art, programming comprising additional functionalities (referred to as “apps”) may be downloaded into tablet computer 202 via, for example, WiFi interface 818, USB 816, external memory 804, or any other convenient method. As discussed previously, one such app may comprise a remote control app, for example as that described in co-pending U.S. patent application Ser. No. 13/329,940 of like assignee and incorporated herein by reference in its entirety, which app may be for use in commanding the operation of devices 106, 108, 110 and/or 120 via device 100. In order to initially configure device 100 to match the devices to be controlled and to establish an appropriate command matrix, tablet computer 202 may also be provisioned with a setup app 214, either as part of a remote control app or as separately downloadable item. With reference now to FIG. 9 such a setup app, upon being invoked at step 902 may initially request that the user place all of the devices to be controlled into a known state, e.g., powered on, in order to enable the device detection and/or testing steps which follow. Device detection may be active and/or passive as desired, for example, by directly requesting device identifying information and/or by monitoring communications to “sniff” for device identifying information. The device detected data will be a data that is unique to the device and may also include a data that is usable to obtain a command code set for the appliance, e.g., a brand, type, and model for the device.

Next, at step 904 the setup app may determine, based on data obtained, those devices which are CEC-enabled. This may be accomplished by communicating a request to the device 100, which at step 906 may cause the programming to scan connected HDMI devices for devices which are CEC-enabled and/or identifiable via interaction over the HDMI interface, for example as described in co-pending U.S. patent application Ser. No. 13/198,072, of like assignee and incorporated herein by reference in its entirety, and communicate such device identities to the setup application. Thereafter, at step 904 the setup application may determine if additional non-CEC devices are connected to the device via the HDMI interface. This may be accomplished by requesting the programming to scan for any further HDMI connections at step 910 and communicate the findings back to the setup application. Though not illustrated, it will be appreciated that where appropriate for a particular embodiment the UCE programming may conduct similar scans to in order to discover devices connected via Ethernet, USB, Bluetooth, RF4CE, WiFi, thread, Internet, cellular, etc., where such interfaces may be provisioned to a UCE.

Thereafter, at step 912 the setup application may display a listing of detected devices to the user. At step 914, the user may be prompted to enter device identifying information for those HDMI or otherwise connected devices which were detected but not identified, i.e., for which a type, brand and model number was not obtained, as well as identifying information regarding any additional devices which may form part of the system to be controlled but are not discoverable as described above (for example devices such as AV receiver 120 or CD player 408 which may be responsive only to unidirectional IR commands). As noted, such identifying information may take the form of user-entered data such as an device type, brand and model number, or a setup code from a listing in a user guide; or may take the form of scanned or electronic information such as a digital picture of the device itself or of a bar code, QR code, or the like associated with device; near field acquisition of RFID tag data; etc.; or any combination thereof as appropriate for a particular embodiment. In any event the system will maintain a record of detected devices even if the user and/or the system has not mapped a particular type, brand and device type information to the device identifying data obtained via the methods noted.

Once appropriate identifying information has been acquired, at step 916 the setup app may communicate that information to a database server, for example server 206, for performance of step 918, comprising identification of and retrieval of command codeset and capability data corresponding to the identified devices from a database 207, and provision of this data to the setup application for processing and ultimate transfer to the device 100. As will be appreciated, the transferred codeset data may comprise complete command data values and formatting information, may comprise pointers to command data values and formatting information already stored in the memories 502 and/or 802/804 of the device upon which the setup application is currently resident, or a combination thereof. Where necessary, for example when database 207 may contain alternate codesets for an identified device, or where uncertainty exists regarding a particular device model number, etc., at steps 920, 922, and 924 various control paradigms and/or command data sets may be tested against the devices to be controlled. Such testing may take the form of soliciting user response to effects observable commands, monitoring of HDMI interface status changes as described for example in U.S. patent application Ser. No. 13/240,604, of like assignee and incorporated herein by reference in its entirety, or any other method as convenient for a particular application. Once appropriate codesets have been fully determined, at steps 926,928 and 930 a suitable preferred command matrix, for example as illustrated in FIG. 7, may be constructed and stored into the memory 502 of example device 100, the matrix being constructed by considering the communication capabilities and functionalities of the devices identified via the above-described processes.

In order to select the optimum command method for each function of each configured device any suitable method may be utilized, for example a system-wide prioritization of command media and methods by desirability (e.g. apply IP, CEC, IR in descending order); device-specific command maps by brand and/or model; function-specific preference and/or priority maps (e.g. all volume function commands via IR where available); etc.; or any combination thereof. The exact selection of command method priorities or mapping may take into account factors such connection reliability, e.g. wired versus wireless, bidirectional versus unidirectional communication, etc.; speed of command transmission or execution; internal priorities within an device, e.g. received IP received packets processed before CEC packets, etc.; type of protocol support (e.g. error correction versus error detection; ack/nak, etc.); or any other factors which may applied in order to achieve optimum performance of a particular embodiment.

As will be appreciated, the construction of said preferred command matrix may be performed at the database server or within the setup application, or a combination thereof, depending on the particular embodiment. Once a preferred command matrix has been finalized and stored in the device, at step 932 a series of desired device configurations associated with specific user activities may be configured and stored into the device, as will now be described.

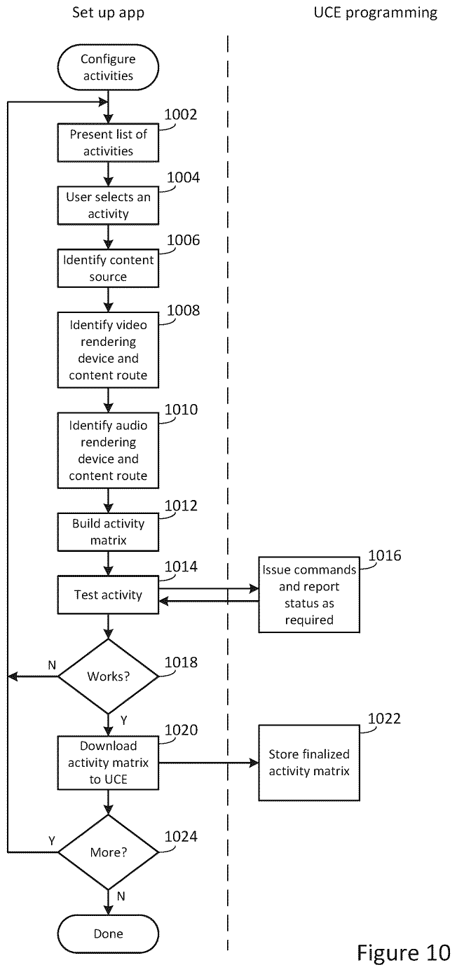

Upon completion and storage of a preferred command matrix, an example setup application may subsequently guide a user through a series of steps in order to establish the desired device configurations for a series of possible activities. With reference to FIG. 10, at step 1002, the user may be presented with a list of possible activities, e.g., “Watch TV”, “Watch a movie”, “Listen to music”, etc. In some embodiments, the user may also be able to edit activity titles and/or create additional user defined activities. At step 1004 a user may select a particular activity for configuration, for example “Watch TV”. At step 1006, the user may be prompted to identify the content source for the activity being configured, for example cable STB/DVR 110 for the example “Watch TV” activity. Such a prompt may take the form of a listing of eligible devices as determined during the foregoing device set up steps; explicit user entry of a device type; etc. Next, at steps 1008 the user may be prompted in a similar manner to select video and audio rendering devices for use in this activity, for example TV 106 and AVR receiver 120 respectively. Depending upon the system topography and the interfaces in use (i.e. HDMI/CEC, IP, analog, etc.) the set up application in concert with the device programming may be able to ascertain which input port of each rendering device is attached to the content source device identified for this activity and/or if any intermediate switching device is in use (for example AV receiver 420 of the system illustrated in FIG. 4). Where such information is obtainable, the set up application may automatically create all or part of an appropriate rendering device input selection for the activity being configured. If not, at steps 1008 and 1010, the user may be additionally requested to identify the applicable content route(s) to the rendering devices, e.g., input port numbers, presence of intermediate switches, etc.

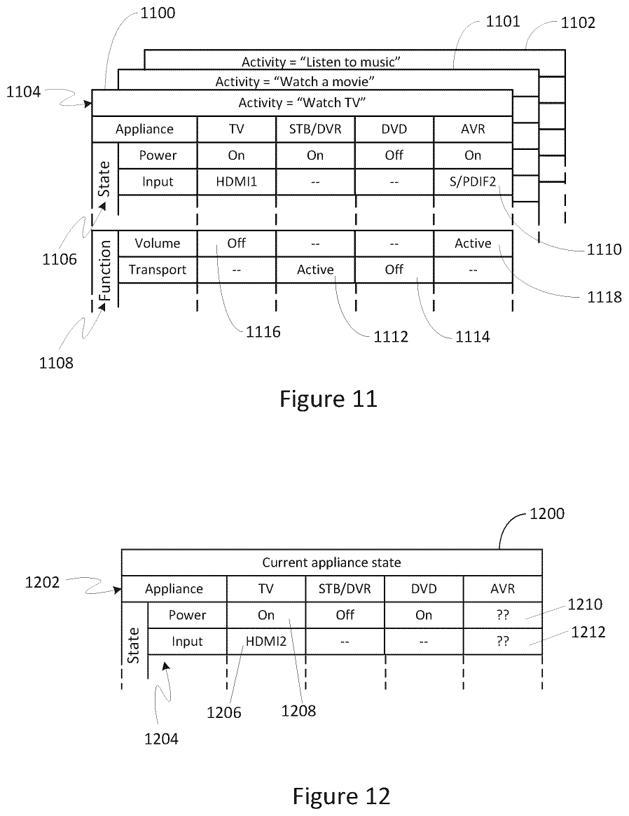

During or upon conclusion of steps 1004 through 1010, the set up application may construct an activity matrix, for example as illustrated in FIG. 11. By way of example, activity matrix 1100 for a “Watch TV” activity may comprise a series of cells, for example 1110 or 1112, each corresponding to a desired configuration of a particular state 1106 or function 1108 of a specific device 1104 during the specified activity. By way of example, cell 1110 may indicate that the input of AV receiver 120 is to be set to “S/PDIF2”, while cells 1112 and 1114 may indicate that transport function commands (e.g., “play”, “pause”, “fast forward” etc.) are to be directed to STB/DVR 110 and not to DVD 114. In this regard, it will be appreciated that while in some embodiments the assignment of functions such as, for example, volume control, to specific devices during a particular activity may be performed within an individual control device, i.e., the control device may determine the device to which volume control commands are to be directed, in a preferred embodiment this assignment may be performed within the device, thereby ensuring consistency across each activity when multiple control devices are present in an environment, for example devices 102 and 104 of the environment illustrated in FIG. 1.

Returning now to FIG. 10, at steps 1014 and 1016 the newly-constructed activity matrix 1100 may be tested by causing the programming, utilizing preferred command matrix 700, to issue the commands necessary to place the identified devices into the desired state and thereafter receiving verification at step 1018 that the desired activity was successfully initiated. It will be appreciated that such verification may comprise, for example, detection and reporting of HDMI or other content streams and/or device status by the programming by directly monitoring CEC status or by using methods such as described for example in U.S. patent application Ser. No. 13/240,604; solicitation of user input confirming correct operation; monitoring for presence or absence of analog input signals; recording of device status or error messages; etc.; or any combination thereof as appropriate for a particular embodiment.

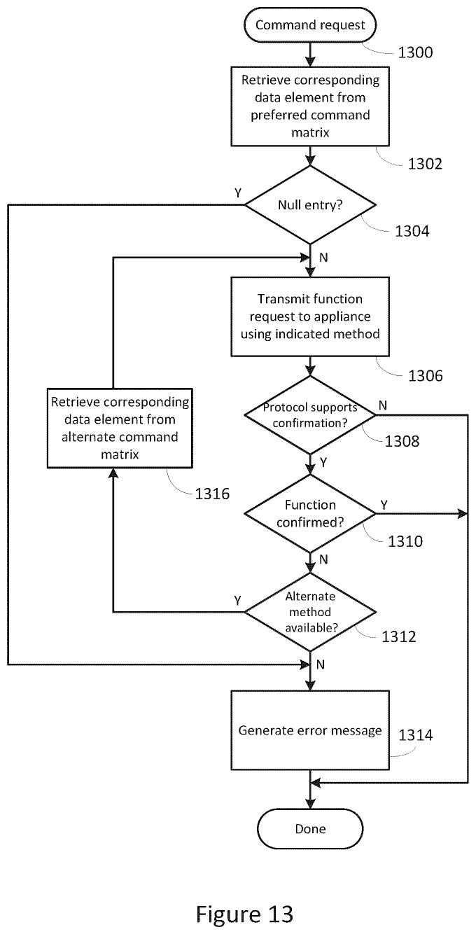

If testing is unsuccessful, at step 1018 the application may return to step 1002 to allow reconfiguration of that activity and/or definition of alternative activities. If testing was successful, at steps 1020 and 1022 the completed activity matrix, for example 1100 as illustrated in FIG. 11, may be transferred for storage in memory 502. Thereafter, at step 1024 the user may be offered the opportunity to return to step 1002 to define additional activity configurations, for example 1101,1102 as illustrated in FIG. 11, or to exit the activity configuration process. With reference now to FIG. 13, the series of steps performed by the programming in order to convey a function command to an device in accordance with a command request 1300 received from a control device such as remote control 102 or 200, smart device 104 or 202, etc., or in accordance with an internally generated requirement resulting from receipt of an activity request (as will be described hereafter) may initially comprise retrieval from a preferred command matrix that data element which corresponds to the requested command and target device. By way of specific example, receipt of a “TV power on” request from remote control 102 or the like at a device provisioned with the preferred command matrices illustrated in FIG. 7 may cause retrieval of data element 720, indicating that the command is to be communicated to the TV device, e.g., television 106, using an HDMI CEC command. At step 1304, the programming may determine if the retrieved value constitutes a null element. If so, the referenced device does not support the requested command and accordingly at step 1314 an error message may be generated and the process thereafter terminated. As will be appreciated, the exact nature of such an error message may depend upon the particular embodiment and/or the requesting control device: for example, if the request originated from a control device which is in bidirectional communication with the device the error may be communicated back to the requesting device for action, i.e., display to the user, illuminate a LED, activate a buzzer, etc. as appropriate. Alternatively, in those embodiments where the functionality is incorporated into a device that performs additional functions, such as an AV switch, that device's front panel display may be utilized.

If the retrieved preferred command matrix element data is valid, at step 1306 the device may communicate the corresponding function command to the target device using the indicated command value and transmission method, e.g., for the example data element 720 this may comprise issuing a CEC “power on” command to CEC logical device address zero (TV) via the HDMI interface 508. Once the command has been issued, at step 1308 the programming may determine if the communication interface and protocol used in issuing the command provides for any confirmation mechanism, i.e., explicit acknowledgement of receipt, monitoring of HDMI status on an interface, detection of a media stream or HDCP handshake, etc. If not, for example the command was issued using a unidirectional IR signal and no other confirmation means such as power or input signal monitoring is available, the programming may simply assume that the command was successful, and processing is complete. If, however, confirmation means exists, at step 1310 the programming may wait to determine if the command was successfully executed. Once positive confirmation is received, processing is complete. If no confirmation or a negative confirmation is received, at step 1312 the programming may determine if an alternative method is available to communicate the command to the target device. Returning to the specific example presented above this may comprise accessing a secondary command matrix 716 in order to determine if an alternative communication method is available for the specific function, e.g., “TV power on.” If an alternative does exist, at step 1316 the substitute command value and transmission method may be retrieved, and processing may return to step 1306 to initiate an alternative attempt. Returning again to the specific example, if the CEC “power on” command corresponding to data element 720 of matrix 700 issued to TV 106 cannot be confirmed, an IR “power on” command encoded according to SIRCS (Sony Infrared Control System) in correspondence with the equivalent data element in secondary matrix 716 may be attempted as a substitute.

In addition to relaying individual command requests as described above, an example device may also support activity selection, whereby receipt of a single user request from a control device may cause a series of commands to be issued to various devices in order to configure a system appropriately for a particular user activity, such as for example, watching television. To this end a set of matrices defining desired equipment states suitable to various activities, for example as illustrated at 1100 through 1102 of FIG. 11, may be stored in memory 502 for access by the programming when executing such a request. As illustrated in FIG. 12, in some embodiments the programming may maintain an additional matrix 1200 representative of the current state of the controlled devices, arranged for example by device 1202 and by operational state 1204. By way of example, data elements 1206 and 1208 in the illustrative table 1200 may indicate that TV 106 is currently powered on (1208) with HDMI port number 2 selected as the input (1206). The data contents of the elements in such a table may be maintained in any convenient manner as appropriate to a particular embodiment, for example without limitation retrieval of HDMI/CEC status; monitoring input media streams and/or HDCP status; measuring power consumption; construction of a simulated device state such as described for example in U.S. Pat. No. 6,784,805; etc.; or any combination thereof. In the case of certain devices, such as for example AV receiver 120 which may be controllable only via unidirectional IR, the current state of the device may not be discernible. In such cases, a null data element 1210 maybe entered into example matrix 1200 to indicate that this device may require configuration using discrete commands only and/or user interaction. As will be appreciated, in some embodiments the data contents of the illustrative table may be maintained in memory 502 on an ongoing basis by the programming, while in other embodiments this data may be gathered “on the fly” at the time the activity request is being processed. Combinations of these methods may also be used, for example “on the fly” gathering for devices connected via an HDMI bus combined with maintenance of a simulated state for devices controlled via IR signals.

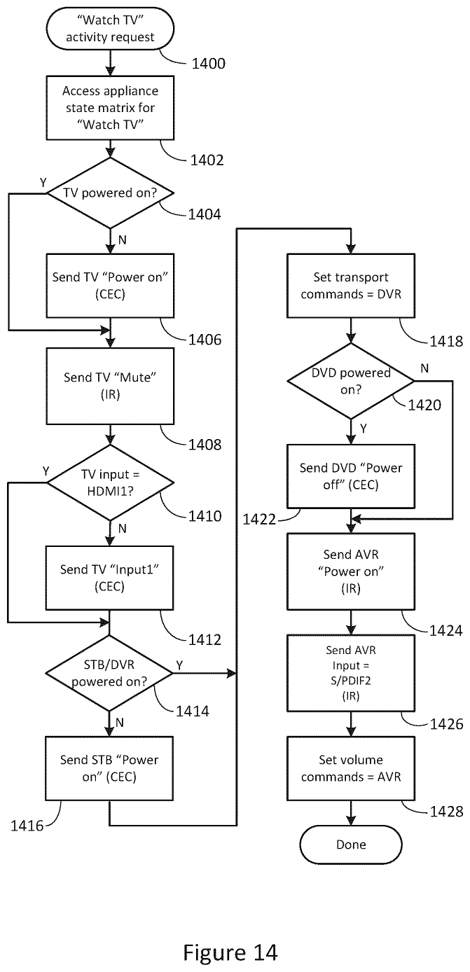

In order to configure a group of devices for a desired activity, the programming may compare a desired state matrix, for example 1100, to a current state matrix, for example 1200, element by element, issuing commands as necessary to bring devices to the desired state. By way of example, an example series of steps which may be performed by the programming of a device in order to affect a “Watch TV” activity configuration will now be presented in conjunction with FIG. 14. For the purposes of this example, the reader may also wish to reference the equipment configuration of FIG. 1 and the activity and current state matrices 1100 and 1200 of FIGS. 11 and 12.

Upon receipt of a “Watch TV” request 1400, at step 1402 the example programming may access an applicable device state matrix 1100. Next, at step 1404 it may be determined by the programming whether the present “power” state of TV 106 as indicated by current state matrix 1200 matches the desired state stored in the corresponding data element of matrix 1100. If the states match, processing may continue at step 1408. If the states do not match, at step 1406 a “power on” command may be communicated to TV 106. As will be appreciated from the earlier discussion in conjunction with FIG. 13 and inspection of example preferred command matrix 700, in the illustrative system communication of the “power on” command to TV 106 may comprise a CEC command issued over HDMI connection 112. Next, at step 1408 a “mute” command may be communicated to TV 106, since element 1116 of illustrative matrix 1100 indicates that TV 106 is not the primary audio rendering device. In accordance with preferred command matrix 700, communication of the “mute” command to TV 106 may comprise an IR transmission 114. Thereafter, at steps 1410,1412 the active input of TV 106 may be set to “HDMI 1” via a CEC command, and at steps 1414,1416 a CEC “power on” command may be communicated to STB/DVR 110 if that device is not already powered on. At step 1418, the example programming may set an internal status to indicate that future transport command requests (e.g., play, pause, FF, etc.) should be routed to STB/DVR 110, as indicated by element 1112 of matrix 1100. Thereafter, at steps 1420,1422 a CEC “power off” command may be communicated to STB/DVR 108 if that device is not already powered off. Thereafter, at steps 1424 and 1426 “power on” and “input S/PDIF2” commands may be communicated to AV receiver 120 via IR signals. As will be appreciated, it may not be possible to determine the current status of AV receiver 120, as indicated for example by elements 1210 and 1220 of matrix 1200, and accordingly so-called “discrete,” or explicit, function commands may be issued which may establish the desired status regardless of the current state of the device. Finally, at step 1428 the example programming may set an internal status to indicate that future volume control command requests (e.g. volume up/down, mute) should be routed to AV receiver 120, as indicated by element 1118 of matrix 1100, where after processing of the activity request is complete.

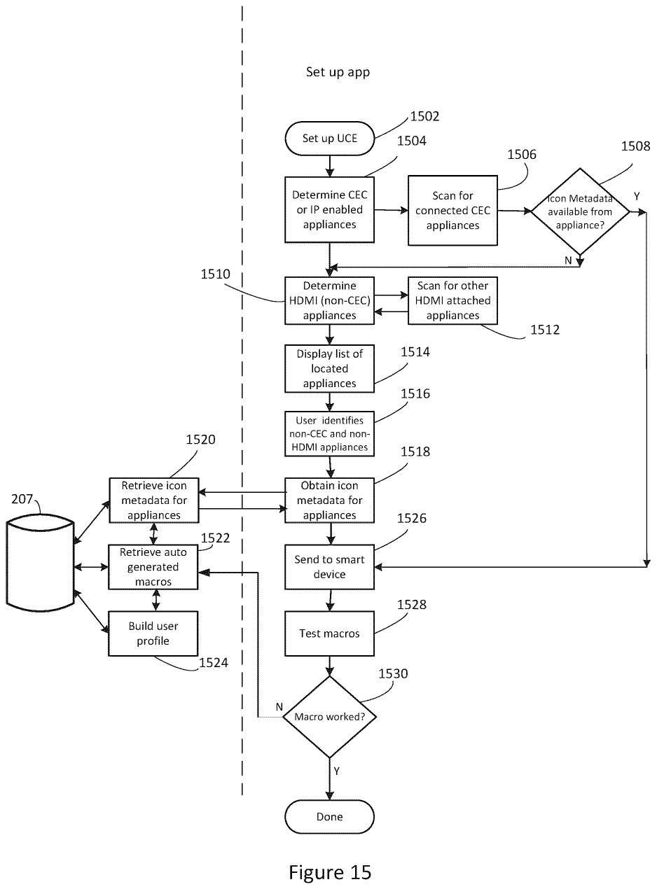

As noted above, the example programming may also support activity selection, whereby receipt of a single user request from a smart device may cause a series of commands to be issued to various devices in order to configure a system appropriately for one or more user activities, such as “watch TV,” “watch movie,” “listen to music,” etc. To setup the user interface of the smart device to support such macro command functionality, an example method is illustrated in FIG. 15. More particularly, with reference to FIG. 15, upon invocation of a setup app at step 1502 a user may be requested to place all of the devices to be controlled into a known state, e.g., powered on or already joined in a wireless network, in order to enable the device detection and/or testing steps which follow. Next, at step 1504 the setup app may determine the identity of those devices which are CEC-enabled or IP enabled. This may be accomplished by communicating a request to a device having the programming which at step 1506 may cause the programming to scan connected HDMI devices for devices which are CEC-enabled and/or identifiable via interaction over the HDMI interface, for example as described in co-pending U.S. patent application Ser. No. 13/198,072, of like assignee and incorporated herein by reference in its entirety, and communicate such device identities to the setup application. In this regard, Ser. No. 13/198,072 describes that CEA standard CEA-861B specifies that a digital video source may optionally insert a periodic Source Product Description information frame into its output video stream. Next, at step 1508 the setup app may also determine if the devices have any associated icon information (for example stored as metadata on the device, available from a remote server, or the like) as well as information related to interface connection types, e.g., WI-FI, HDMI input/output, for use in the creation of supported macros. If the icon information is available, the icon information may be sent to the smart device by the device and/or retrieved by the smart device using other information provided by the device as appropriate as shown in step 1526. An icon corresponding to the icon information may then be automatically added to the user interface of the smart device whereupon an activation of the added icon may be used to provide access to command and control functionalities associated with the corresponding controllable device, including commands in the form of a listing of automatically generated macros available for that controllable device as described below. Thus, icon information provided to the smart device may be used in connection with information stored on the smart device, stored in the internet cloud and/or at a remote server to automatically add an icon to the user interface of the smart device where the icon can be in the form of a logo for the controllable device, icons in the form of logos for content (e.g., television station logos) that can be accessed via the controllable device, etc. In a further illustrative embodiment, icons may function as soft keys which may be selected to cause the performance of a further action for example, to display a device control page (e.g., to present television control soft keys such as channel up, channel down, etc.), cause the transmission of commands, etc. as described for example in U.S. patent application Ser. No. 10/288,727, (now U.S. Pat. No. 7,831,930) of like assignee and incorporated herein by reference in its entirety, or any other method as convenient for a particular application.

The setup application then continues to step 1510 (after scanning for CEC connected devices as discussed above) whereat the setup application may next determine if additional non-CEC devices are connected to the device via the HDMI interface. This may be accomplished by requesting the programming to scan for any further HDMI connections at step 1512 and communicate the findings back to the setup application. Though not illustrated, it will be appreciated that, where appropriate for a particular embodiment, the programming may conduct similar scans in order to discover devices connected via Ethernet, USB, Bluetooth, RF4CE, WiFi etc., where such interfaces may be provisioned to a device having the programming.

Thereafter, at step 1514 the setup application may display a listing of detected devices (both identified and not yet identified) to the user. At step 1516, the user may then be prompted to enter device identifying information for those HDMI or otherwise connected devices which were detected but not identified, as well as identifying information regarding any additional devices which may form part of the system to be controlled but which were not discoverable as described above (for example devices such as AV receiver 120 or CD player 408 which may be responsive only to unidirectional IR commands). Without limitation, such identifying information may take the form of user-entered data such as a device type, brand and model number, or a setup code from a listing in a user guide; or may take the form of scanned or electronic information such as a digital picture of the device itself or of a bar code, QR code, or the like associated with device; near field acquisition of RFID tag data; MAC address; etc.; or any combination thereof as appropriate for a particular embodiment.

Once appropriate identifying information has been acquired, at step 1518 the setup app may communicate that information to a database server, for example server 206, for performance of step 1520 in which the database server uses the identification information to retrieve icon information as needed (e.g., when such data was not obtainable from the device), command information as discussed previously, and in step 1522, to automatically generate macros which correspond to the device or a plurality of devices considering their capability data as maintained in a database 207 and/or as retrieved from the devices. Any such data gathered from and/or created by the server 206 will then be provisioned to the setup application for processing and ultimate transfer to the smart device and/or programming as required. As will be appreciated, the transferred information and/or metadata may comprise complete command data values, device input/output data and current status, formatting information, pointers to command data values and formatting information already stored in the memories 502 and/or 802/804 of the device upon which the setup application is currently resident, etc. Where necessary, for example when database 207 may contain alternate codesets, icon metadata, or macro information for an identified device, or where uncertainty exists regarding a particular device model number, etc., at steps 1528, 1530, and 1522 various control paradigms and/or command data sets may be tested against the devices to be controlled. Such testing may take the form of soliciting user response to effects observable commands, monitoring of HDMI interface status changes as described for example in U.S. patent application Ser. No. 13/240,604, of like assignee and incorporated herein by reference in its entirety, or any other method as convenient for a particular application. Once appropriate codesets and macro operations have been fully determined, at steps 1528 and 1530 a suitable preferred user profile 1524, may be constructed and stored into the memory 502 of example device 100, the user profile 1524 being constructed by considering the communication capabilities and functionalities of the devices identified via the above-described processes.

In order to select the optimum command method for each function of each configured device any suitable method may be utilized, for example a system-wide prioritization of command media and methods by desirability (e.g. apply IP, CEC, IR in descending order); device-specific command maps by brand and/or model; function-specific preference and/or priority maps (e.g. all volume function commands via IR where available); etc.; or any combination thereof. The exact selection of command method priorities or mapping may take into account factors such connection reliability, e.g. wired versus wireless, bidirectional versus unidirectional communication, etc.; speed of command transmission or execution; internal priorities within an device, e.g. received IP received packets processed before CEC packets, etc.; type of protocol support (e.g. error correction versus error detection; ack/nak, etc.); or any other factors which may applied in order to achieve optimum performance of a particular embodiment.

As will be appreciated, the construction of said user profile 1524 may be performed at the database server or within the setup application, or a combination thereof, depending on the particular embodiment.

Once device identifying information has been acquired, the device identifying information may also be used to track and classify devices within a given ecosystem, such as a home environment. In this regard, the system may be adapted to actively obtain device identifying information directly from each device, e.g., by polling, and/or may be adapted to passively obtain device identifying information from all wireless messages transmitted within an ecosystem, including communications transmitted by unpaired or neighboring devices. To allow for the tracking and classifying of the device, the device identifying information at least uniquely functions to uniquely identify a given device. As will become apparent, by tracking and classifying devices within an ecosystem, the system can provide, among other improved services, improved personalization, advertising, entertainment, energy management, and/or security services considering the home context. The home context may be a built view of the home layout and device behavior patterns over time. It will also be appreciated that, to the extent a device is linked to a user within the system, the information may equally be used to optionally track a user, e.g., to track locations within and interactions with the devices of the ecosystem.

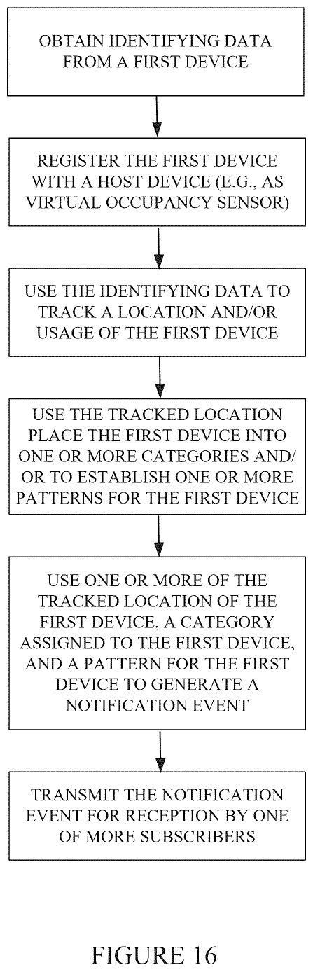

Turning to FIG. 16, an example series of steps is illustrated which steps may be performed to use a tracked condition of a first device to enhance services provided by one or more apps installed on the first device and/or other devices, e.g., notification subscribers. More particularly, based on monitoring the environment through an amount of time, the programming can classify devices in the environment based on a number of parameters and can start tagging the devices in the environment (both those on the home network as well as those visiting or nearby the environment). In a preferred example, devices are classified as fixed or moving/mobile devices. Fixed devices are those that do not change position relative to the host over time. A moving or mobile device does change position relative to the host over time. A predetermined amount of threshold movement from a reference point or device may be established to distinguish a fixed device from a moving device and the threshold movement amount may be set for the entire ecosystem or on an area-by-area basis as desired. Movement of a device relative to an established barrier or boundary within the ecosystem, e.g., a doorway into a room, may also be utilized to distinguish between a moving device and a fixed device. The time frame selected for this determination is preferably set to be sufficiently long to allow for distinguishing between fixed and mobile devices, e.g., recognizing that phones and the like may be “fixed” for short periods of time, such as overnight, but over longer periods of time will be determined to come and go within the environment.

In addition to classifying devices as fixed or mobile/moving, devices can also be classified as being near or far relative to the host device. A threshold amount of movement and/or a barrier used as a reference to establish nearness or farness, i.e., proximity, may also be utilized in this classification example.

Still further, it is to be appreciated that the tracked devices can be placed into multiple categories. For example, a phone may generally be a “mobile device” but overnight (such as between the hours of 8 pm and 6 am) the same phone may be a device that is “non-moving” or “static.” Accordingly, the categorizations can be used to build patterns for devices over periods of time, such as hourly habits in a day, daily habits in a week, etc. As noted, the patterns developed for device can also be used to identify patterns of individuals owning a device in the home, such as device usage, home and away times, etc. Still further, the tracking of devices can be used to identify patterns of guests, such as babysitter or the like. Guests in this example would be those individuals having a device that is registered within the ecosystem as belonging to a resident within the home. Once the pattern data for devices and/or individuals is generated by use of device tracking and tagging, such data can be provided to various applications within the ecosystem for use in improving the application related services. In addition, the data generated by tracking the locations of devices, the categorized states of devices, such as leaving or returned home, and/or how a device is being used at a location and/or within a given state, e.g., when and where apps are being used, can be provided to various application within the ecosystem for use in improving the application related services. For example, higher level applications can subscribe to notification(s) tied to a specific device, such as the device coming/leaving home, coming closer to a host or moving further away, a device deviating from a determined pattern, etc., whereupon the applications can be triggered to provide a service based upon the notification(s) provided. This can also be done for a group of devices. For tracking devices, well known positioning methodologies and/or positioning devices (e.g., GPS, beacons, etc.) may be used as best fit a particular purpose. Tracking of presence, movement and/or proximity of devices and, accordingly, users can be performed using WiFi radio, Bluetooth or the like. Pattern determinations may include analysis of historical location, movement, etc. and, in some cases, averages of collected data may be utilized to place devices and/or users into one or more classifications.

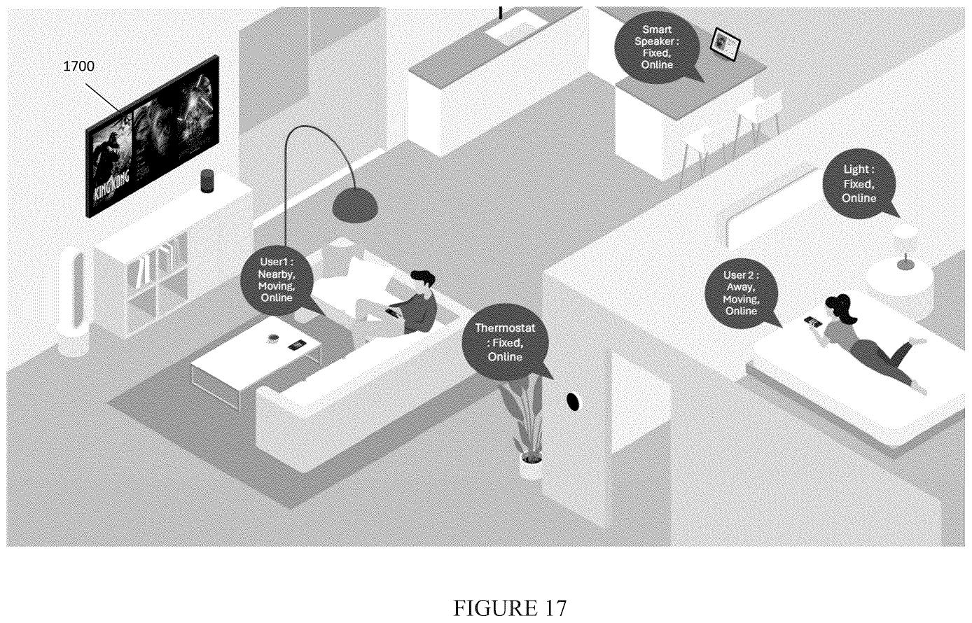

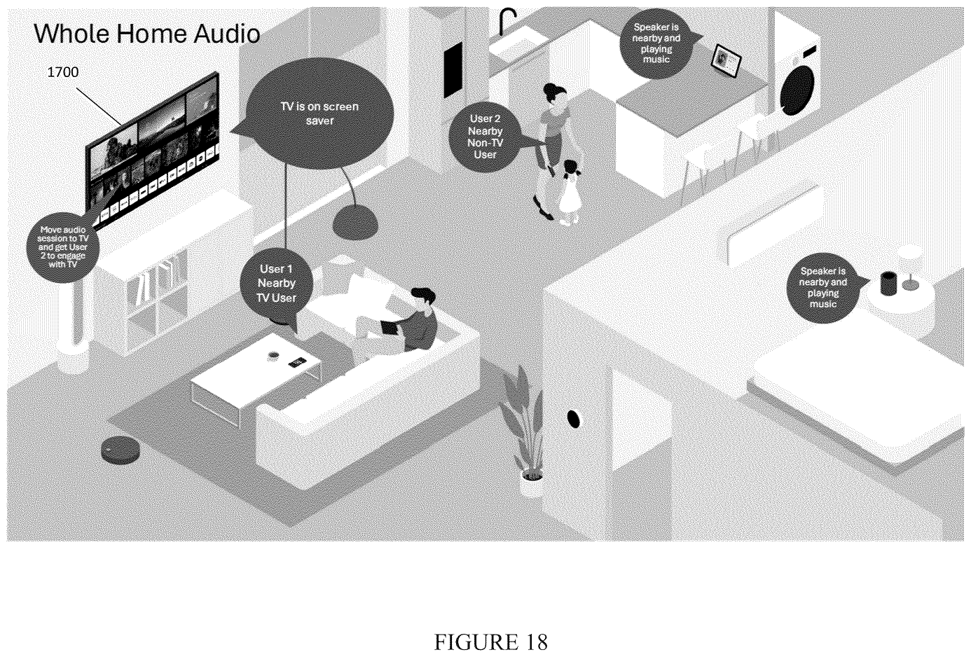

By way of non-limiting example, FIG. 17 illustrates an environment in which devices and users have been assigned to one or more categories. In this example, considering the TV 1700 as being the Hub device, e.g., the device from which proximity, movement, etc. is measured, the system has determined, based on a tracking of a device that has been associated with user 1, that user 1 is currently in the nearby or proximate category, that user 1 is in the moving category, e.g., that user 1 is or has been moving, and that user 1 is in the online category. Similarly, the system has determined that the thermostat, the light, and the speaker are each in the fixed and online categories while user 2, who in this example is within a different room or living space relative to TV 1700, is within the away, moving, and online categories. The system is thus able to categorize the various devices within the environment, e.g., the smart speakers located in different rooms, the phones, the smart watches, the lights, the thermostats, etc., using software running either inside a home entertainment device 1700, or running inside a smart home hub, or a broadband gateway. In addition, it is to be noted that devices and users can be included in different categories relative to one or more devices executing the described programs. For example, while user 1 may be considered to be nearby TV 1700 in the illustrated example, user 1 can also be classified as being away from another TV, hub device, etc., that is located within another room of the house. In addition, as shown in FIG. 18, given a category assigned to a user, such as user 1 being categorized as being proximate to the TV 1700, user 1 can also be categorized in another category as needed for any particular purpose, such as “using the TV.”

Once the patterns and/or notifications events for a system are discerned and/or established, the patterns and/or notification events can be used to provide more intelligence to applications that can be used for building advertising, entertainment, energy management or security use cases. For example, an application can provide occupied or unoccupied related services for a home based on the historical understanding of the patterns for fixed vs moving personal devices, as well weekly patterns. The services can be further improved by using event notifications, such as by causing a motion sensor to send a signal to an application when motion is detected and having the application tie the reported motion to a pattern of device “moving” in the monitored area and/or a notification of a sensed presence of a device within the ecosystem “near” to or within the monitored area. The service provided by the application in response to such discerned patterns and/or notification events can include causing a television to turn on and tune to a predetermined channel, e.g., when it is determined that dad gets home at night, to turn on and play music - preferably tuned to a media source that is based on historical device usage.

In a similar manner a service provided by an application that is provided with discerned patters and/or notification events can relate to climate control and/or energy usage. In such use cases, patterns and events related to occupancy are most likely to be considered critical when setting energy efficient thresholds. In this regard, rather than setting thresholds based on whether the home is occupied or not occupied, the patterns and/or notifications events could be used to change the settings based on knowing who is home and the typical desired rates for when that specific subset of users is home. In this regard, the system can fully automate a smart thermostat application to infer home occupancy or not based on patterns seen/learned in the home on typical devices that come and leave versus those that stay, and adapt through time, accordingly, even adapting to a brand new device that shows up in the home. For example, the system may cause an HVAC system to anticipate the arrival of a particular user based on one or more established patterns and have the HVAC system ready the home for the arrival of the user, e.g., to be at the user's desired temperature.

In an additional example, the ability to monitor the status of devices within the ecosystem will allow the system to function and a “virtual occupancy sensor.” For example, a host device, such as a smart TV or smart hub, can generate notification events to report on the status of one or more tracked devices and can make the notification events available to all other devices and ecosystems in the home by exposing itself as a “Virtual Occupancy Sensor” in a “Matter” protocol network. In this manner, the applications running on such device can adapt as needed, e.g., to effect energy efficient modes based on occupancy the host device determines in the home.

It will also be appreciated that knowing who is at home and/or away and/or knowing who is close to, moving toward, moving away from home etc., can be useful in an entertainment and advertising use case. For example, a media device application can use the discerned patterns and/or notification events to organize a home screen dashboard (and advertisements presented by the media device) based on historical preferences for one or more users, e.g., last used, most used apps for when that person or persons has been nearby the media device. The patterns and/or event notification may additionally allow for refreshing/changing of an ad when same person is there, allow for showing the ad when a new person is nearby the TV, and the like, to ensure that an ad or multiple ads reach the most people in the home.

The event notifications will additionally be useful in allowing applications to share information for the purpose of providing better services. For example, in response to a host device sensing a music stream being played on the home speakers, e.g., that a google home, apple Homepod, Sonos speaker, etc. is being used, the hub can send an event notification to a further device, such as a smart TV, to cause a TV application to automatically show a notification on the TV screen where the notice has info about what the user is playing and where the user is playing it. Similarly, the sharing of event notifications will allow a user to control (transport, volume, etc.) the media playing device(s). Furthermore, when using discerned patterns for one or more devices, a host device can additionally identify which speakers are close to or far from a TV (same room, different room) and can prioritize showing notifications/controls for speakers within the same room while moving move notifications for speakers in other rooms to a side panel that does not distract the user. When tracking users via their device, discerned patterns and/or notification events can also be utilized to influence behavior. For example, a hub device can build patterns for different users in the home to identify which users spend the most amount of time or least amount of the in front of a TV. Based on the determined patterns of which users spend the least amount of time in front of TV, as soon as an application is provided with a notification event that indicates that the user is close to TV, the application can cause the TV to show a “udge” notifications of cool or different or new engaging experiences on the TV that may “hook” the user to start engaging with the TV ecosystem more.

As noted above, a system that has the device discovery capabilities described herein can discover and identify devices with device type, brand and/or model information. In the condition if a device is trackable for its online/offline state, then this information can be used to further enable other use cases. In an example, a mobile phone or an Apple watch will reconnect to WiFi and get IP access to the Internet when the owner comes home. Because the system can detect when such a device becomes online, the system will establish a trace for this device with its online and offline state transition. Thus, when a user moves with these personal devices and an online to offline state transition occurs, this transition may indicate to the system that the user has left the home. Similarly, a device switch from offline state to online may indicate to the system that the user is back home. The status of the user, derived from the status of the device, can then be used to trigger events as also noted, e.g., to control a thermostat, turn on or off an appliance, etc.

Among all devices that can be monitored for its online/offline state, some of them, such as a television, rarely go offline. These devices can be excluded from the movement tracking algorithm.

Given a long period of time for initial tracking, the system can identify a subset of devices that are online and offline with certain usage patterns. Using such information, a device can be categorized as a mobile or static device. For example, a device that goes offline and comes back online can be categorized as a mobile device. The system can use different discovery techniques to detect and categorize a device as a mobile device.

By war of non-limiting example, a device that is identified as a mobile phone device type based on information obtained from the device can be categorized as a mobile device. When information indicates that a device that has a brand such as Apple, Samsung or Google and/or the model information for a device is known to be associated with a mobile device, the device can be categorized as a mobile device. Similarly, a device that uses a random generated MAC address can be assumed to be a personal device that is a mobile device.

Using the categorization of devices, in an example the system can determine that the home is unoccupied when it is determined that all of the known devices of the mobile device category are offline, and events associated with an unoccupied home can be executed by the system. Similarly, if any device of the mobile device category transitions from offline to online, the system can derive that a user has come home so the home is occupied, and events associated with an occupied home generally and/or specific to the owner(s) of the transitioning device can be executed by the system.

In yet another scenario, the system can take into consideration different weekdays or times of the day to get better results. For example, if a trend is discovered that a home is normally unoccupied after 9a m and then occupied at 5 pm, the system can turn on the AC or heat at 4:30 pm to make the home more comfortable. The system may determine what time to start/stop AC when the user gives authorization to the system. The system may also recommend to a user a set of rules for the user to adjust and fine tune HVAC settings to achieve comfort and energy efficiency.

As also noted, the system may associate a user with a device. In a household with multiple users, linking a device to a specific user can help enable other use cases. For example, the user who setup the system using his/her mobile phone will be recognized and linked with that device, categorized as a mobile device. Then, by following the mobile phone that was used to set up the system, the system can identify any additional devices that show the same online offline pattern. The system can then extend the mapping of the user to the other mobile devices having the same pattern. In a similar manner, other mobile devices that are showing a different pattern can be grouped and lined to another user, so the system can identify different sets of mobile devices associated with the other users in the household.

Beyond online and offline detection for a mobile device, if the system is given access to other data points such as signal strength of connectivity technologies, the system can then further harvest on those data points and derive the vicinity information. For example, a WiFi RSSI signal for each device is tracked so the system can tell how far or near a device is from a reference point. The RSSI data can be provided by the host system. In one scenario, the data point is collected at regular intervals. In another scenario, the data point is tracked continuously using a secondary WiFi interface.

As will be appreciated, the RSSI reading will be different from device to device, so obtained brand and/or model information obtained for devices can be used to improve the accuracy of vicinity detection based on RSSI. In an example, the RSSI reading is associated with a unique device ID, such as MAC address. With the device model information, a specific device mapping table can be used to calibrate the data points. In addition, a dynamic threshold can be established based on a device model, brand, type and its RSSI reading to derive a device that is close to a reference device within the system, or not close, to trigger a certain rule. In this manner, if a phone is near the TV while an audio streaming is playing on another device, the system can redirect the audio stream to the TV.

A host or reference device within the system can also sense its room information based on other clues besides the RSSI reading. For example, a living room TV, when acting as a system hub, will detect, using RSSI, if a phone is nearby at night indicating that a user leaves the phone in the charging mode in the living room. Likewise, when a mobile device shows a lower RSSI reading during the night, the system can determine it is taken to another room, such as a bedroom. A threshold can be established to tell for each specific device when the RSSI is drop to a level, it means the user is leaving the space around the hub device, e.g., the living room.

If multiple hub devices are at a user's home, the devices can coordinate with each other to get a better overview on the user movement across Room A (where a first hub device stays) and Room B (where another hub device stays).

In another example, the connectivity solution may be extended to include or use as an alternative Bluetooth low energy signals, ultra-wide band (UWB) signals, etc. In this regard, it will be appreciated that RF connectivity data can also enhance the device discovery processes by feeding the system with a MAC address discovered through a RF monitoring mechanism. While not required, it is preferred that the device communications described herein are intended to occur within the home network, not through the cloud, to ensure that data remains localized and private.

In an example system, the device discovery function may be triggered by a calling device, e.g., a hub device. Once the function is triggered, the function starts with the discovery stage followed by the lookup stage. In the discovery stage, the calling device will go through a mDNS and SSDP discovery flow in sequence by sending a mDNS query and a M-Search request and a listening for the responses for a certain period of time. Any new discovered devices will be added to the discovered device list first. In the lookup stage, the device will trigger a predictive device lookup call, e.g., as utilized to configure a controlling device, and update the device GUID received during the discovery phase with a brand, model, name, etc. based on the responses. In a preferred architecture, the system has a discovery manager, SSDP listener, mDNS listener, an ARP listener, a MAC scan with UDP ping service, and message handler tasks running all the time to implement device discovery and presence detection functions.

In an example system, the discovery process may be caused to commence in response to a system event. A system event may include one or more of when a hub device restarts with an Internet connection, switches to another WiFi network, after WiFi onboarding for the first time, etc. A system event may also be a user prompting to trigger discovery. By default, all discovery methods would be performed in response to an event trigger. Results from a discovery process can be persisted and performed as desired, e.g., for a 7-day window on an hourly basis, and the prediction for each device as to whether or not the device is Fixed or is Mobile based on an analysis of its signal strength variation can likewise be persisted and performed as desired.

It will further be appreciated that, since a hub device might not have been running continuously for a given period of time, e.g., over the last 7 days, it may be desired to determine which days and hours of any stored data contain valid data. To this end, an assumption may be made that, if a given hour in each day does not have a positive presence data for at least one device, then that hour is bit valid, and that data be used in any further calculations.

For each device, it's presence data may also be evaluated for each hour of each day in order to calculate a Daily Presence Percentage (DPP). That is essentially just the count of hours in which the device is reported as being present divided by the number of hours. For example, if a device is present 18 hours out of a 24-hour day, the DPP would be 18/24=75%. However, if the same device was present 18 hours, but only 18 hours were valid based on Day-Hour Validation, then the DPP would be 18/18=100%. Such data may be used in connection with the labeling of a device. For example, the DPP can be used to label as device as constant or temporal. A constant device is assumed to always be there and is likely unmoving. A device will be classified as Constant if its Daily Presence Percentage is always greater than or equal to an agreed upon Constant Percentage. The default value for Constant Percentage is 90%. Meanwhile a temporal device is temporary and not always present. They are likely movable. A device will be classified as Temporal if at least once its Daily Presence Percentage is less than or equal to the Temporal Percentage. The default value for Temporal Percentage is 85%

While the initial determination of Constant and Temporal is based entirely on Daily Presence Percentages. Additional data can be used to help correct and filter these initial determinations. For example, an ongoing measurement and analysis of signal strengths may allow the client to determine whether or not a given device is fixed or mobile based on whether or not its signal strength is relatively constant or has significant variations. These labels are supplied in the uploaded presence data and can be used to augment Constant and Temporal classification. Similarly, the prediction of the device type of a device can be used to distinguish between devices that should likely be classified as Constant or Temporal. In addition, since a MAC address has reserved ranges for personal devices such as phones or smart watches, devices with MAC addresses in such ranges can be classified as likely Temporal.

As also noted above, it is desired to also determine groups of devices that might pertain to a particular user or a group of users with similar schedules. This may be accomplished by determining which devices have a high degree of correlation between their Presence Percentage on an hourly basis, for valid hours. All devices that have a matching presence history of greater than or equal to the User Group Percentage can be assigned to the same User Group. The current default value for the User Group Percentage is 90%. A device may have membership in multiple User Groups.

Routing of messages between appliances can be performed using one or more priorities that are established for the appliance(s) and/or users. In some instances, one or more users may manually establish rules/conditions that will function to determine how, when, and/or to where notifications of a given type are to be transmitted. Such initially established rules/conditions can then be modified and adjusted by the system as desired based on the system learning behaviors. In some instances, the rules/conditions that will function to determine how, when, and/or to where notifications of a given type are to be transmitted may be pre-established by appliance manufactures. For example, a manufacturer of a notification source device (e.g., an alarm device) may pre-establish routing rules based on brands of notification sink devices (e.g., cell phones) and the routing rules may favor the sending of notifications to a notification sink device of the same brand over notification sink devices of other brands. The system may then configure itself to route messages using those rules that applicable to the devices that are detected and/or registered within the system. The rules may be further adjusted/modified based on the learned behaviors. Accordingly, the interaction and person tracking functionalities described herein may be utilized to automatically generate and/or to adjust, as desired, how, when, and to where a notification message is to be transmitted to a notification sink device, i.e., the subject system will allow for messages to be routed considering one or more of a level of (1) privacy, (2) importance, (3) target (e.g., household vs user), and/or (4) timeliness while also reducing the delivery of redundant/spammy messages to a user (e.g., the sending of multiple message to a user across different places/platforms they can be reached).

For determining how, when, and/or to where a notification is to be transmitted, the system and method will particularly use one or more of the methods described herein to identify one or more parameters related to appliance(s) and user(s) within the ecosystem and will use the identified one or more parameters to determine how to best route notifications (also referred to herein as messages) to one or more appliances linked to one or more users. Generally, the parameters will be used to determine which one or more transmission routing rules/priorities are to be utilized. A parameter that can be utilized to determine how, when, and to where to route a message may be a current state of an appliance (e.g., location and/or power status) and/or a current state a tracked user, such as at home, moving toward an appliance within an ecosystem, proximity to a known appliance within the ecosystem, etc. In this manner, the system may be setup to only send certain notifications to a user when they are determined to be at home and may route such notifications to an appliance that the user is known to be interacting with, proximate to, or approaching within the home, e.g., an appliance having a speaker that the user is or will be near.

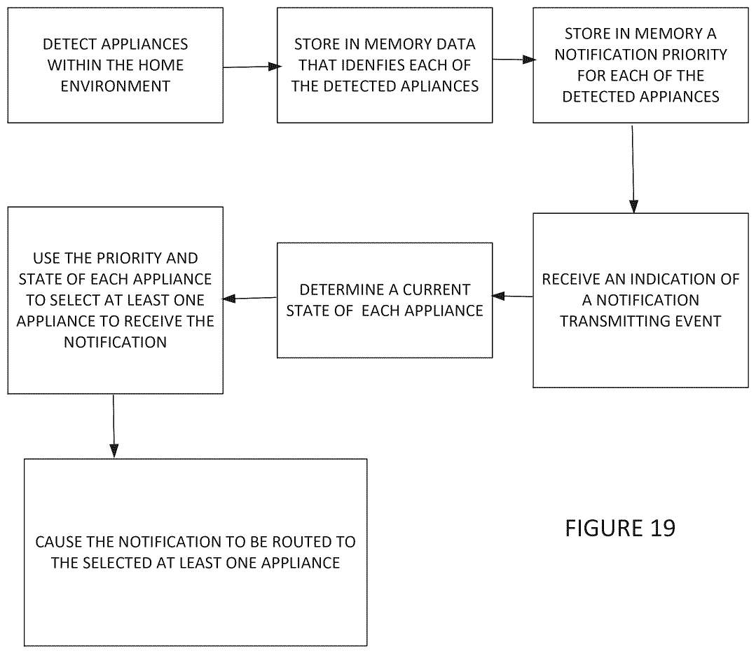

By way of further example with reference to FIG. 19, the system may be setup, using any of the methods described above, to passively monitor if any of a given user's personal devices, such as phone or watch are home. When a notification is generated within the system, the notification is determined to be a notification that should be routed to one or more users (e.g., parents) when it is determined that the one or more users are home (e.g., an intercom message), and the user(s) are, in fact, determined to be home, the notification can be routed directly to that user's phone or watch. That the user is at home can be determined, as described above, when it is determined that the user's phone or watch is at home. In some examples, the notification can be routed only to the appliance that is closest to or being interacted with by the one more users at the time the notification is to be transmitted to avoid the transmission of multiple notifications to that user. Similarly, a notification generated by a security device, such as a smoke detector, home security alarm, etc. can be filtered to only be pushed to a phone of a user if it determined, using the methods described herein, that the user is not already at home. If the user is determined to be at home, the notification need not be sent to the user because it can be assumed that the user, at home, will already be aware of the state of the system. Yet further, notifications can be routed based on a determined power state of different appliances in the home. Thus, if a TV is known by the system to be powered on, some notifications, e.g., those with higher security and less privacy, can be routed to the TV system.

In view of the foregoing, it is seen that, by using one or more states of one or more appliances and/or one or more users within an ecosystem, the subject system and method may route notifications to only those appliances that are determined to be best used to convey a notification. As such, the subject system and method will have the advantage of reducing the amount on unnecessary notifications that need to be transmitted within the system, e.g., a message will be routed only to the most appropriate device(s) to thereby conserve resources that would otherwise be used to unnecessarily transmit phone notification, SMS, or TV screen messages when not needed.

The management of notification routing as described herein can be performed in whole or in part at a notification source device or a hub device (e.g., a home security panel) communicatively linked to one or more notification source devices and one or more notification sink devices. While various concepts have been described in detail, it will be appreciated by those skilled in the art that various modifications and alternatives to those concepts could be developed in light of the overall teachings of the disclosure. For example, in an alternate embodiment of UCE functionality, in place of a preferred command matrix such as illustrated in FIG. 7, the programming of an example UCE may utilize a command prioritization list, for example a prioritization list “IP, CEC, IR” may cause the UCE programming to first determine if the requested command can be issued using Internet Protocol, only if not, then determine if the requested command can be issued using a CEC command over the HDMI interface, and only if not, then attempt to issue the requested command via an infrared signal. Such a prioritization reflects an example preference of using bi-directional communication protocols over uni-directional communication protocols over line of sight communication protocols, e.g., IR, when supported by the intended target device.

Further, while described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

All patents cited within this document are hereby incorporated by reference in their entirety.

What is claimed is:

1. A method for routing a notification message from a notification source device to a one of a plurality of notification sink devices, comprising:
in response to detecting the plurality of notification sink devices within a home environment, storing in a memory a plurality of first data each of which is indicative of a priority that is assigned to each one of the plurality of notification sink devices; and
in response to the notification message being generated by the notification source device, determining an operating state of each of the plurality of notification sink devices, using the determined operating state of each of the plurality of notification sink devices and the first data to identify the one of the plurality of notification sink devices, and causing the notification message to be transmitted to the one of the plurality of notification sink devices.

2. The method as recited in claim 1, wherein the operating state of each of the plurality of notification sink devices comprises a power state of each of the plurality of notification sink devices.

3. The method as recited in claim 1, wherein the operating state of each of the plurality of notification sink devices comprises a location state of each of the plurality of notification sink devices.

4. The method as recited in claim 1, wherein the notification source device comprises an alarm condition sensing device and wherein the plurality of notification sink devices each comprises a device having an audio and/or visual output device.

5. The method as recited in claim 4, wherein the plurality of notification sink devices comprises at least one smart phone and at least one smart television.

6. The method as recited in claim 1, wherein the operating state of each of the plurality of notification sink devices comprises a location state of at least one user relative to each of the plurality of notification sink devices.

7. The method as recited in claim 6, further comprising receiving from one or more sensing devices data for use in determining the location state of the at least one user relative to each of the plurality of notification sink device.

8. The method as recited in claim 7, wherein the one or more sensing devices comprises a smart phone.

9. The method as recited in claim 6, wherein the operating state of each of the plurality of notification sink devices additionally comprises a power state of each of the plurality of notification sink devices.

10. The method as recited in claim 9, wherein the operating state of each of the plurality of notification sink devices additionally comprises a location state of each of the plurality of notification sink devices.

11. A non-transitory, computer readable media having stored thereon instruction wherein the instructions, when executed by a processing device, perform steps for routing a notification message from a notification source device to a one of a plurality of notification sink devices, the steps comprising:
in response to detecting the plurality of notification sink devices within a home environment, storing in a memory a plurality of first data each of which is indicative of a priority that is assigned to each one of the plurality of notification sink devices; and
in response to the notification message being generated by the notification source device, determining an operating state of each of the plurality of notification sink devices, using the determined operating state of each of the plurality of notification sink devices and the first data to identify the one of the plurality of notification sink devices, and causing the notification message to be transmitted to the one of the plurality of notification sink devices.

12. The non-transitory, computer readable media as recited in claim 11, wherein the operating state of each of the plurality of notification sink devices comprises a power state of each of the plurality of notification sink devices.

13. The non-transitory, computer readable media as recited in claim 11, wherein the operating state of each of the plurality of notification sink devices comprises a location state of each of the plurality of notification sink devices.

14. The non-transitory, computer readable media as recited in claim 11, wherein the notification source device comprises an alarm condition sensing device and wherein the plurality of notification sink devices each comprises a device having an audio and/or visual output device.

15. The non-transitory, computer readable media as recited in claim 14, wherein the plurality of notification sink devices comprises at least one smart phone and at least one smart television.

16. The non-transitory, computer readable media as recited in claim 11, wherein the operating state of each of the plurality of notification sink devices comprises a location state of at least one user relative to each of the plurality of notification sink devices.

17. The non-transitory, computer readable media as recited in claim 16, further comprising receiving from one or more sensing devices data for use in determining the location state of the at least one user relative to each of the plurality of notification sink device.

18. The non-transitory, computer readable media as recited in claim 17, wherein the one or more sensing devices comprises a smart phone.

19. The non-transitory, computer readable media as recited in claim 16, wherein the operating state of each of the plurality of notification sink devices additionally comprises a power state of each of the plurality of notification sink devices.

20. The non-transitory, computer readable media as recited in claim 19, wherein the operating state of each of the plurality of notification sink devices additionally comprises a location state of each of the plurality of notification sink devices.
